(19) United States
(12) Patent Application Publication
(10) Pub. No.: US 2026/0367864 A1
(43) Pub. Date: Nov. 19, 2026

(54) AUDIO PLAYBACK METHOD, APPARATUS, ELECTRONIC DEVICE, AND STORAGE MEDIUM

(71) Applicant: Linkplay Technology Inc., Newark, CA (US)

(72) Inventors: Jiqiang WU, Newark, CA (US); Shuai ZHAO, Newark, CA (US); Lifeng ZHAO, Newark, CA (US)

(73) Assignee: Linkplay Technology Inc., Newark, CA (US)

(21) Appl. No.: 19/293,271

(22) Filed: Aug. 7, 2025

(30) Foreign Application Priority Data
May 13, 2025 (CN) 202510609618.6

(51) Int. Cl. G06F 3/16; G06F 3/01

(52) U.S. Cl. CPC G06F 3/165; G06F 3/011; G06F 2203/011

(57) ABSTRACT

An audio playback method is applied to an audio playback system, the audio playback system includes at least two audio playback devices, and the method includes: obtaining at least one type of target data in response to a playback command for target audio; where the at least one type of target data includes any one of the following: position information of a detection target, configuration information of each audio playback device in the audio playback system, historical control information of the audio playback system, attribute information of the target audio, and current spatiotemporal information of the audio playback system; determining at least one target audio playback device from the audio playback system according to the at least one type of target data; and playing the target audio through the at least one target audio playback device.

### CROSS-REFERENCE TO RELATED APPLICATIONS

This application claims priority to Chinese Patent Application No. 202510609618.6, filed on May 13, 2025, which is incorporated by reference herein in its entirety.

### TECHNICAL FIELD

The present disclosure relates to the field of audio playback technologies, in particular to an audio playback method, an audio playback apparatus, an electronic device and a storage medium.

### BACKGROUND

In an audio playback system with a plurality of playback devices, when determining which one or more playback devices are used for audio playback each time, the conventional approach typically involves shortcut default configuration that designates one or more user-prespecified playback devices as default devices for every playback instance; or to have the user manually specify the playback devices through operational input. This approach lacks flexibility. When a user intends to use non-default playback devices for a specific playback instance, cumbersome device selection operations are required, demonstrating low intelligence levels.

### SUMMARY

In a first aspect, the embodiments of present disclosure provide an audio playback method applied to an audio playback system, the audio playback system includes at least two audio playback devices, and the method includes: obtaining at least one type of target data in response to a playback command for target audio; wherein the at least one type of target data includes any one of the following: position information of a detection target, configuration information of each audio playback device in the audio playback system, historical control information of the audio playback system, attribute information of the target audio, and current spatiotemporal information of the audio playback system; determining at least one target audio playback device from the audio playback system according to the at least one type of target data; and playing the target audio through the at least one target audio playback device.

In a second aspect, the embodiments of present disclosure provide an audio playback apparatus, applied to an audio playback system, the audio playback system includes at least two audio playback devices, and the apparatus includes: an obtaining module, configured to obtain at least one type of target data in response to a playback command for target audio; where the at least one type of target data comprises any one of the following: position information of a detection target, configuration information of each audio playback device in the audio playback system, historical control information of the audio playback system, attribute information of the target audio, and current spatiotemporal information of the audio playback system; a determining module, configured to determine at least one target audio playback device from the audio playback system according to the at least one type of target data; and a playback module, configured to play the target audio through the at least one target audio playback device.

In a third aspect, the embodiments of present disclosure provide an electronic device, including a processor and a memory, where the memory has stored thereon machine-executable instructions that are capable of being executed by the processor, and the processor is configured to execute the machine-executable instructions to perform the above-mentioned audio playback method.

In a fourth aspect, the embodiments of present disclosure provide a computer-readable storage medium on which computer-executable instructions are stored, where the computer-executable instructions, when invoked and executed by a processor, cause the processor to implement the above-mentioned audio playback method.

The additional features and advantages of the present disclosure will be given in the following description, and part of which may become apparent, or may be understood through the implementation of the present disclosure. The objectives and other advantages of the present disclosure are achieved and obtained by the parts particularly pointed out in the description, claims, and drawings.

To make the objectives, features and advantages of the present disclosure more apparent and understandable, preferred embodiments are particularly exemplified below and described in detail as follows with reference to the accompanying drawings.

### BRIEF DESCRIPTION OF THE DRAWINGS

In order to illustrate the technical solutions of the embodiments of the present disclosure or the prior art in a clearer manner, the drawings required for the description of the embodiments of the present disclosure or the prior art will be described hereinafter briefly. Apparently, the following drawings merely relate to some embodiments of the present disclosure, and based on these drawings, a person of ordinary skill in the art may obtain other drawings without any creative effort.

FIG. 1 is a flowchart of an audio playback method according to the embodiments of the present disclosure.

FIG. 2 is a schematic diagram of an audio playback apparatus according to the embodiments of the present disclosure.

FIG. 3 is a schematic diagram of an electronic device according to the embodiments of the present disclosure.

### DETAILED DESCRIPTION OF THE EMBODIMENTS

In order to make the objects, the technical solutions and the advantages of the present disclosure more apparent, the present disclosure will be described hereinafter in a clear and complete manner in conjunction with the drawings. Apparently, the following embodiments merely relate to a part of, rather than all of, the embodiments of the present disclosure, and based on these embodiments, a person skilled in the art may, without any creative effort, obtain the other embodiments, which also fall within the scope of the present disclosure.

Terms such as “first”, “second”, “third” and “fourth” (if any) in the description, claims and the drawings of the present disclosure are used to differentiate similar objects, and not necessarily used to describe a specific sequence or order. It should be appreciated that the data used in this way may be interchanged under an appropriate circumstance, so that the embodiments of the present disclosure described herein may be implemented in a sequence other than those illustrated or described herein. Moreover, terms “include”, “have” and any other variation thereof are intended to encompass non-exclusive inclusion, such that a process, method, system, product or device including a series of steps or units includes not only those steps or elements, but also other steps or units not explicitly listed, or steps or units inherent in the process, method, system, product or device.

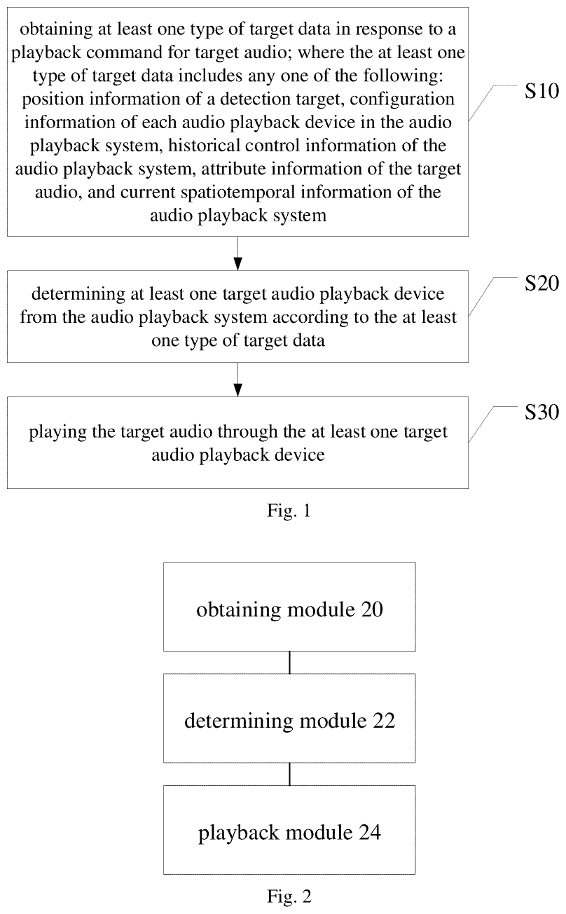

To facilitate technical comprehension, the specific process of the embodiments of the present disclosure is described below. The embodiments of the present disclosure are applied to an audio playback system that includes at least two audio playback devices. As shown in FIG. 1, an audio playback method according to the embodiments of the present disclosure includes the following steps.

Step S10, obtaining at least one type of target data in response to a playback command for target audio; where the at least one type of target data includes any one of the following: position information of a detection target, configuration information of each audio playback device in the audio playback system, historical control information of the audio playback system, attribute information of the target audio, and current spatiotemporal information of the audio playback system.

A user may trigger a playback command for the target audio through a terminal device. For example, the user may trigger the playback command for the target audio through such devices in the audio playback system as a television, control panel, mobile device (e.g., smartphone), thereby causing the target audio to be played through an audio playback device in the audio playback system. The playback command for the target audio may also be automatically triggered, e.g., through timer-based triggering, which will not be particularly defined herein.

The target data refers to data used for determining the target audio playback device. In this embodiment, one or more types of target data may be obtained. The target data may be, but is not limited to, any one or more of the following: position information of a detection target, configuration information of each audio playback device in the audio playback system, historical control information of the audio playback system, attribute information of the target audio, and current spatiotemporal information of the audio playback system. The target data may also be other data types that can be used for determining the target audio playback device, which will not be particularly defined herein.

The detection target may be any object whose position can be detected. By way of non-limiting examples, the detection target may be a device, a biological organism or a specific marker. For example, the detection target may be such a device capable of indicating a wearer's location as a mobile phone, a wristband, a watch. The detection target may also be any human body, a human body with facial features that meet the predetermined requirements, a human body with voiceprint features that meet the predetermined requirements, a human body with fingerprint features that meet the predetermined requirements, etc., that can be used to indicate the human body's location. The detection target may also be a specific marker with a predetermined icon, predetermined shape, or predetermined weight. The detection target is not limited to these examples.

For the detection target of the device type, the position information of the detection target may be obtained through satellite positioning, WiFi signal detection, Bluetooth Low Energy (BLE) signal strength detection, and other manners. The manners of WiFi signal detection and BLE signal strength detection have higher accuracy in indoor positioning and can improve the accuracy of audio playback device determination.

The configuration information of the audio playback device may include hardware configuration information, software configuration information, and related attribute information of the audio playback device. For example, the hardware configuration information may include a model of a digital to analog converter (DAC), an output power and a signal-to-noise ratio of an amplifier, interface parameters, frequency response range, impedance, sensitivity, etc. The software configuration information may include operating system parameters, driver version, sampling rate, bit depth, sound enhancement, network streaming protocol, equalizer, etc. The related attribute information may include an identifier, a name, spatial location information, whether it is connected to an audio-visual device, etc. The configuration information of the audio playback device is not limited to these examples.

The historical control information of the audio playback system includes the control information for controlling the audio playback system during a preceding predetermined time period. For example, the historical control information may include a user at a specific time point in history triggering the playback of some audio on a specific audio playback device without a control device/manner. The historical control information of the audio playback system is not limited to these examples.

The attribute information of the target audio may include attributes related to sound quality, attributes related to content type, attributes related to genre, or other attributes that can be used to select the audio playback device. The attribute information of the target audio may also be categorized into technical attributes and perceptual attributes. For example, the technical attributes may include a sample rate, a bit depth, the quantity of channels, a bit rate, an audio file format, and a frequency response, etc. The Perceptual attributes may include pitch, loudness, timbre, spatialization, clarity, etc. The attribute information of the target audio is not limited to these examples.

The current spatiotemporal information refers to the spatiotemporal information of the environment in which the audio playback system is located, which may include current time information, current weather information, current network environment information, current ambient lighting information, current ambient sound information, and other information that can be used to represent the current environmental status. The current spatiotemporal information is not limited to these examples.

Step S20, determining at least one target audio playback device from the audio playback system according to the at least one type of target data.

In this embodiment, according to each type of obtained target data, at least one audio playback device that matches the target data may be determined from the audio playback system. In one embodiment of the present disclosure, matching degree calculation between each type of target data and each audio playback device may be performed, to obtain a first matching degree of each audio playback device corresponding to each type of target data. Next, all first matching degrees corresponding to the audio playback devices are aggregated to obtain a target matching degree corresponding to each audio playback device. The audio playback device with a target matching degree higher than a preset matching degree threshold is determined as the target audio playback device.

For example, the audio playback system includes audio playback device A and audio playback device B, and the obtained target data includes target data A and target data B. first matching degrees of audio playback device A with target data A and target data B, as well as first matching degrees of audio playback device B with target data A and target data B, may be calculated. Next, the first matching degrees of audio playback device A with target data A and target data B are aggregated to obtain the target matching degree of audio playback device A, and the first matching degrees of audio playback device B with target data A and target data B are aggregated to obtain the target matching degree of audio playback device B.

Next, it is determined whether the target matching degree of audio playback device A and the target matching degree of audio playback device B are higher than the preset matching degree threshold. If the target matching degree of audio playback device A is higher than the preset matching degree threshold, audio playback device A is determined as the target audio playback device. The same applies to audio playback device B, which will not be particularly defined herein.

In one embodiment of the present disclosure, it may also generate audio playback device characteristic data matching the target data according to the target data through a preset device feature generation algorithm, and determine at least one target audio playback device matching the audio playback device feature data from the audio playback system according to the audio playback device feature data.

Step S30, playing the target audio through the at least one target audio playback device.

After determining the target audio playback device, the target audio playback device can be controlled to play the target audio. This enables intelligent selection of playback devices for audio playback, rather than determining the preset playback device through the default setting. Consequently, the intelligence level of the audio playback system is significantly enhanced.

In one embodiment of the present disclosure, playback parameters of the audio may also be determined according to the target data. When playing the target audio through the target audio playback device, the playback is performed according to the determined playback parameters. The playback parameters may include, but are not limited to, volume, equalizer settings, buffer size, playback mode, etc., which will not be particularly defined herein.

In the audio playback method of the embodiments of the present disclosure, the audio playback device is predicted through multi-dimensional target data. This enables intelligent selection of playback devices for audio playback, rather than determining the preset playback device through the default setting. Consequently, the intelligence level of the audio playback system is significantly enhanced.

Next, for each type of target data, a detailed description regarding the manner for determining the audio playback device will be provided.

In one embodiment of the present disclosure, the at least one type of target data is the position information of the detection target, and the detection target is a target device or a target organism; the determining at least one target audio playback device from the audio playback system according to the at least one type of target data includes: calculating, according to the position information, a proximity level between the detection target and a preset audible zone of each audio playback device in the audio playback system; wherein the preset audible zone of each audio playback device is used to indicate a target connected space where the corresponding audio playback device is located; and determining, from the audio playback system, at least one target audio playback device whose proximity level is greater than or equal to a preset proximity level threshold.

In the case where the target data is the position information of the detection target, when determining the target audio playback device, the proximity level between the detection target and an audible zone of each audio playback device is calculated according to the position information of the detection target, and the audio playback device with a proximity level greater than or equal to a preset proximity level threshold is determined as the target audio playback device.

The preset audible zone of the audio playback device refers to a zone where the loudness of sound at a specific volume (sound pressure level) is greater than or equal to a preset loudness threshold. In other words, when audio is played at a certain volume, if the loudness of the sound measured at a certain position is less than the preset loudness threshold, that position does not fall within the preset audible zone. The preset audible zone is related to a placement position of the audio playback device, the connectivity of the space in which the audio playback device is located, etc. The present disclosure is not limited thereto.

For example, assuming an audio playback system in a home environment, with audio playback device A placed in room A. In this room, when audio playback device A plays audio at a certain volume, all positions within Room A exhibit sound loudness greater than or equal to the preset loudness threshold, while any position outside Room A exhibits loudness below the preset loudness threshold. In this case, Room A is the preset audible zone for audio playback device A. The present disclosure is not limited thereto.

When calculating the proximity level between the detection target and the preset audible zone of each audio playback device in the audio playback system, the proximity level corresponding to the detection target within the preset audible level of the audio playback device may be determined as 100%. For the detection target outside the preset audible zone of the audio playback device, the proximity level may be calculated according to a distance between the detection target and a nearest boundary position of the preset audible zone. For example, the proximity level decreases by 1% for every 10 cm increase in distance. The specific details are not limited here.

The detection target may be a target device or a target organism, e.g., a target mobile phone, a target wristband, a target watch, human body, or a target human body. When determining the target audio playback device through the detection target's position, it is able to sense the detection target's position for audio playback, achieving seamless control with high intelligence level.

In one embodiment of the present disclosure, the proximity level Pᵢ between the detection target and the preset audible zone of an i-th audio playback device in the audio playback system may also be calculated through a preset proximity level calculation formula:

$${P}_{i} = 100 \% \times ( 1 - min ( \frac{d}{{d}_{max}} , 1 ) )$$

where, d denotes a distance between the detection target and a preset audible zone of the i-th audio playback device in the audio playback system, dₘₐₓ represents the maximum effective distance, when d exceeds dₘₐₓ, the proximity level equals 0. When Pᵢ≥preset proximity level threshold, the i-th audio playback device is determined as the target audio playback device.

For example, there are three smart speakers in a household, numbered Speaker 1 (i=1), Speaker 2 (i=2), and Speaker 3 (i=3), and located in the living room (i=1), bedroom (i=2), and kitchen (i=3), respectively. When a user wearing a smartwatch enters the living room, the system calculates, through Wi-Fi signal strength detection, the distances between the user and the preset audible zones of the three speakers, d₁=2 meters, d₂=8 meters, and d₃=5 meters. Assuming dₘₐₓ=10 meters, the preset proximity level threshold is 60%.

The corresponding proximity levels of the three smart speakers are as follows.

P₁=100%×(1−2/10)=80%

P₂=100%×(1−8/10)=20%

P₃=100%×(1−5/10)=50%

Since P₁>60%, the speaker in the living room (i.e., the first speaker) is determined to be the target audio playback device. When the user issues the voice command “Play today's news,” the system automatically plays the audio through the first speaker without the user having to manually select a device.

This algorithm implements intelligent device selection based on user location, reducing the operations of manual device selection by users and improving the system usability and user experience. In addition, this algorithm adopts a relative distance percentage calculation, and can be applied to application scenarios of different sizes of space, thereby offering better universality.

In one embodiment of the present disclosure, the at least one type of target data is the configuration information of each audio playback device in the audio playback system; the determining at least one target audio playback device from the audio playback system according to the at least one type of target data includes: obtaining an audio-visual type of the target audio, wherein the audio-visual type is used to indicate whether the target audio is video-associated audio or non-video-associated audio; calculating, according to the audio-visual type and the configuration information of each audio playback device, a device compatibility degree for each audio playback device in the audio playback system; determining an audio playback device whose device compatibility degree is greater than a preset device compatibility threshold as the target audio playback device, and obtaining the at least one target audio playback device.

The target audio may be video-related audio or non-video audio. For video-related audio and non-video audio, the system may perform the device compatibility calculation based on the configuration information of different audio playback devices, thereby to obtain the audio playback device that is more in line with the audio-visual type of the target audio.

When calculating the device compatibility degree of each audio playback device, for the target audio being the video-related audio, it is able to calculate the quantity of configuration parameters in the configuration information of each audio playback device that meet audio-visual playback requirements, and determine the device compatibility degree of each audio playback device according to the quantity of configuration parameters. For the target audio being the non-video audio, it is able to calculate the quantity of configuration parameters in the configuration information of each audio playback device that meet the quality of the target audio, and determine the device compatibility degree of each audio playback device according to the quantity of configuration parameters.

When determining the device compatibility degree of each audio playback device based on the quantity of configuration parameters, a ratio of the quantity of configuration parameters to the preset quantity threshold or the maximum quantity of parameters may be calculated, and the ratio is determined as the device compatibility degree of the corresponding audio playback device. The maximum quantity of parameters refers to the maximum value of the quantity of configuration parameters, which will not be particularly defined herein.

In one embodiment of the present disclosure, a configuration compatibility degree between different audio-visual types and different configuration parameters may be set through a preset correspondence relationship. When calculating the device compatibility degree of each audio playback device in the audio playback system according to the audio-visual type and configuration information of each audio playback device, the configuration compatibility degree between each configuration parameter in the configuration information of each audio playback device and the audio-visual type of the target audio may be obtained from the preset correspondence relationship, and a device compatibility degree Cm of an m-th audio playback device in the audio playback system is calculated through a preset device compatibility degree calculation formula:

$${C}_{m} = \frac{\sum ( {w}_{i} \times {L}_{i} )}{\sum {w}_{i}}$$

where, wᵢ represents a weight of an i-th configuration parameter of the m-th audio playback device, and Lᵢ represents the configuration compatibility degree between the i-th configuration parameter of the m-th audio playback device and the audio-visual type of the target audio.

For example, a user requests to play audio from a movie, where audio-visual type of the target audio is the video-related audio. It is assumed that there are three smart speakers in the household, numbered sequentially as Speaker 1 (m=1), Speaker 2 (m=2), and Speaker 3 (m=3), and located in the living room (m=1), bedroom (m=2), and kitchen (m=3) respectively. The configuration parameters for each smart speaker include: the quantity of channels (i=1), audio decoding capability (i=2), power output (i=3), and network connection performance (i=4). The corresponding weights for the configuration parameters are as follows: w₁=0.4, w₂=0.3, w₃=0.2, and w₄=0.1.

Through the preset correspondence relationship, the configuration compatibility level between the configuration parameter of each smart speaker and the video-related audio is obtained as follows.

Living room smart speaker 1: 5.1 channel (L₁=95%), Dolby decoding (L₂=90%), 100 W power output (L₃=85%), and wired connection (L₄=95%).

Bedroom smart speaker 2:2.0 channel (L₁=60%), AAC (Advanced Audio Coding) decoding (L₂=70%), 20 W power output (L₃=60%), and Bluetooth connection (L₄=75%)

Kitchen smart speaker 3: Mono channel (L₁=40%), basic decoding (L₂=50%), 10 W power output (L₃=40%), and WiFi connection (L₄=90%).

Accordingly, the device compatibility levels corresponding to the three smart speakers respectively are calculated and obtained as follows.

C₁=(0.4×95%+0.3×90%+0.2×85%+0.1×95%)/1=91.5%.

C₂=(0.4×60%+0.3×70%+0.2×60%+0.1×75%)/1=64.5%.

C₃=(0.4×40%+0.3×50%+0.2×40%+0.1×90%)/1=48%.

Assuming a preset device compatibility level threshold of 70%, since C₁=91.5%>70%, the smart speaker in the living room is determined as the target audio playback device. This algorithm achieves precise matching between audio types and device configurations through multi-parameter weighted calculations, ensuring optimal sound quality for users. The parameter weights may be dynamically adjusted based on different audio types, so as to achieve the system adaptability while enhancing playback professionalism and user satisfaction.

In one embodiment of the present disclosure, the at least one type of target data is the historical control information of the audio playback system; the determining at least one target audio playback device from the audio playback system according to the at least one type of target data includes: obtaining current time information and genre tag information of the target audio; determining through matching, from the historical control information, at least one target audio playback device with a historical preference degree higher than a preset preference degree threshold, according to the current time information and the genre tag information.

The genre tag information of the target audio is used to indicate the genre of the target audio, such as classical, pop, rock, jazz, film/TV soundtrack, etc. According to the current time information and the genre tag information, it is able to determine through matching, from the historical control information, the target audio playback device that meets the historical preference requirements. This enables the replication of the user's habitual behavior, i.e., playing the audio of a specific audio genre at a specific time, thereby enhancing the user experience in audio playback.

When determining through matching, from the historical control information, at least one target audio playback device with a historical preference degree higher than a preset preference degree threshold, according to the current time information and the genre tag information, it is able to determine whether matching control information exists in the historical control information according to the current time information and genre tag information. If so, the historical preference degree of each audio playback device is calculated according to the matching control information. Next, the audio playback device with the historical preference degree higher than the preset preference degree threshold is determined as the target audio playback device.

When determining whether the matching control information exists in the historical control information, it is able to determine whether there is control information in the historical control information in which playback time is the same as the preset time period of the current time and of which the genre tag is the same. If so, the played audio playback device in the corresponding control information is determined as the preference playback device. When calculating the historical preference degree, the proportion of the quantity of each preference playback device in the total quantity of all preference playback devices is calculated to obtain the historical preference degree corresponding to each preference playback device. For non-preference playback devices, their historical preference degree may be 0, which will not be particularly defined herein.

In one embodiment of the present disclosure, the at least one type of target data is the attribute information of the target audio; the determining at least one target audio playback device from the audio playback system according to the at least one type of target data includes: determining a content type of the target audio according to the attribute information; and determining, from the audio playback system, at least one target audio playback device of which a preset compatible content type matches the content type.

The content type of the target audio refers to a type of text content in the target audio. The target audio may be categorized as a text-containing audio or a non-text-containing audio according to whether the target audio has text. The non-text-containing audio is typically pure music or white noise, and the text-containing audio may be further categorized as a dialogue-containing audio or a non-dialogue-containing audio. The dialogue-containing audio is typically audio from movies and TV shows, and the non-dialogue-containing audio is typically a song. For the non-dialogue-containing audio, the content type may also be categorized according to the emotional tendency of the text content, such as sad, cheerful, angry, or dull, etc., which will not be particularly defined herein.

After determining the content type of the target audio, it is able to match the content type of the target audio with a preset compatible content type of each audio playback device, and the audio playback device of the same preset compatible content type is determined as the target audio playback device, so as to obtain the at least one target audio playback device. Through the content type matching, it is able to enable the playback device to have type memory capability, prevent audio with a non-matching type from being played on an inappropriate playback device, thereby to enhance the user experience.

In one embodiment of the present disclosure, the at least one type of target data is current spatiotemporal information of the audio playback system, and the current spatiotemporal information includes current weather information and/or current time information; the determining at least one target audio playback device from the audio playback system according to the at least one type of target data includes: performing behavioral habit feature and emotional feature prediction according to the current spatiotemporal information, to obtain a feature prediction result; and determining through matching, from the audio playback system, at least one target audio playback device of which a feature matching degree with the feature prediction result is greater than a preset feature matching threshold, according to preset characteristic information of each audio playback device in the audio playback system.

When determining at least one target audio playback device from the audio playback system based on the current spatiotemporal information of the audio playback system, it is able to perform behavioral habit feature and emotional feature prediction according to the current spatiotemporal information according to the current weather information and/or current time information in the current spatiotemporal information, to obtain the user's current behavior habit feature and emotional feature, that is, the feature prediction result.

Next, matching is performed between the feature prediction result and the preset feature information corresponding to each audio playback device, a feature matching degree is calculated, so as to obtain a target feature matching degree corresponding to each audio playback device. The audio playback device whose target feature matching degree is greater than the preset feature matching degree threshold is determined as the target audio playback device.

In one embodiment of the present disclosure, when performing behavioral habit feature and emotional feature prediction, a pre-trained artificial intelligence model may be used to perform the prediction, so as to obtain the feature prediction result. During the matching, the feature matching degree may also be calculated by using a preset feature difference algorithm. The feature difference algorithm may be a Pearson Correlation algorithm, a Spearman's Rank Correlation algorithm, a Mutual Information algorithm, etc., which will not be particularly defined herein.

The above explains the specific manner of determining the target audio playback device for each type of target data. For cases where the quantity of types of target data exceeds one, aggregate calculation may be performed on the target audio playback device determined by each type of target data, to determine the final target audio playback device for playing the target audio.

When performing the aggregate calculation, it is able to calculate the quantity of target audio playback device determined by each type of target data. The audio playback devices whose total quantity exceeds a preset threshold or whose total quantity is the largest are determined as the target audio playback devices for playing the target audio.

In one embodiment of the present disclosure, the determining at least one target audio playback device from the audio playback system according to the at least one type of target data includes: calculating a matching degree between each type of target data and each audio playback device, obtaining a matching degree calculation result corresponding to each type of target data; performing, according to preset weight information corresponding to each type of target data, weighted summation on the matching degree calculation result corresponding to each type of target data, and obtaining a target matching degree for each audio playback device; and determining an audio playback device whose target matching degree is greater than a preset device matching degree threshold as the at least one target audio playback device.

When calculating the matching degree between each type of target data and each audio playback device, it is able to use the specific manner of determining the target audio playback device described above, so as to obtain the matching degree calculation result corresponding to each type of target data.

For example, when the target data is the position information of the detection target, the corresponding matching degree calculation result may be the aforementioned proximity level. When the target data is the configuration information of each audio playback device in the audio playback system, the corresponding matching degree calculation result may be the aforementioned device compatibility degree. When the target data is the historical control information of the audio playback system, the corresponding matching degree calculation result may be the aforementioned historical preference degree. When the target data is the attribute information of the target audio, the corresponding matching degree calculation result may be the content-type matching degree. When the target data is the current spatiotemporal information of the audio playback system, the corresponding matching degree calculation result may be the aforementioned feature matching degree.

After obtaining the matching degree calculation result, it is able to perform weighted summation on the preset weight information of each type of target data and its corresponding matching degree calculation result, thereby obtaining the target matching degree for each audio playback device. Audio playback devices whose target matching degree are greater than the preset device matching degree threshold are determined as target audio playback devices. This enables the determination of target playback devices to incorporate multi-dimensional data calculations, improving both the accuracy of audio playback device determination and the intelligence level of the system.

In one embodiment of the present disclosure, preset weight information αⱼ corresponding to a j-th type of target data is determined through the following formula:

αⱼ=βⱼ×(1+γⱼ×hⱼ)
where βⱼ is a preset base weight for the j-th type of target data; γⱼ is a learning rate coefficient for the j-th type of target data, where γⱼ∈[0,1], and γⱼ is a hyperparameter used to control the degree of parameter adjustment for a machine learning model in each step of an optimization algorithm; hⱼ is a historical success rate index, where hⱼ∈[0,1], and hⱼ is correlated with whether the matching degree calculation result of the corresponding target data successfully predicts the audio playback device actually used by the user.

For example, assume that the first type (j=1) of target data is the location information of the detection target, the second type (j=2) of target data is the configuration information of each audio playback device in the audio playback system, the third type (j=3) of target data is the historical control information of the audio playback system, and the fourth type (j=4) of target data is the current spatiotemporal information of the audio playback system.

Assume that the preset basic weights are as follows: β₁=0.3, β₂=0.3, β₃=0.2, and β₄=0.2; the historical success rate indexes are as follows: h₁=0.6, h₂=0.8, h₃=0.9, h₄=0.7; and the learning rate coefficients are as follows: γ₁=0.5, γ₂=0.5, γ₃=0.7, γ₄=0.6.

Accordingly, the preset weight information αⱼ corresponding to the j-th target data is calculated as follows.

α₁=0.3×(1+0.5×0.6)=0.39.

α₂=0.3×(1+0.5×0.8)=0.42.

α₃=0.2×(1+0.7×0.9)=0.326.

α₄=0.2×(1+0.6×0.7)=0.284.

Normalization may also be performed on αⱼ.

α₁=0.27, β₂=0.29, α₃=0.23, α₄=0.21.

The algorithm with preset weight information achieves intelligent aggregation of multi-dimensional data through dynamic weight coefficients. It can adaptively adjust the weight of each dimension according to historical usage, forming an intelligent system that continuously learns and optimizes.

After obtaining the dynamic preset weight information, weighted summation may be performed on the matching degree calculation results corresponding to all types of target data by using the following preset weighted summation formula to obtain the target matching degree Mᵢ of the i-th audio playback device:

Mᵢ=Σ(αⱼ×Sⱼ)
where Sⱼ represents the matching degree calculation result corresponding to the j-th target data of the i-th audio playback device.

For example, there are three smart speakers in a household, numbered Speaker 1 (i=1), Speaker 2 (i=2), and Speaker 3 (i=3), and located in the living room (i=1), bedroom (i=2), and kitchen (i=3), respectively. Sⱼ of the speaker in the living room (i.e., the first speaker) are as follows: S₁=70%, S₂=95%, S₃=60%, and S₄=80%. Sⱼ of the speaker in the bedroom (i.e., the second speaker) are as follows: S₁=85%, S₂=75%, S₃=90%, and S₄=85%. Sⱼ of the speaker in the kitchen (i.e., the third speaker) are as follows: S₁=50%, S₂=70%, S₃=40%, and S₄=60%.

Accordingly, the target matching degrees corresponding to these three smart speakers respectively are as follows.

M₁=0.27×70%+0.29×95%+0.23×60%+0.21×80%=77.15%.

M₂=0.27×85%+0.29×75%+0.23×90%+0.21×85%=83.2%.

M₃=0.27×50%+0.29×70%+0.23×40%+0.21×60%=55.9%.

In a case that the preset device matching degree threshold is 70%, since M₁=77.15%>70%, the smart speaker in the living room is determined as the target audio playback device. After the terminal selects the actual audio playback device for playback, it may also determine whether the target audio playback device is successfully predicted. In a case that the target audio playback device is the same as the audio playback device selected by the terminal for playback, it means that the prediction is successful; otherwise, it means that the prediction fails. The prediction result (success or failure) may be fed back to the learning module to update the historical success rate index and learning rate coefficient of each dimension.

In one embodiment, the playing the target audio through the at least one target audio playback device includes: sending identifier information of the target audio playback device to a target terminal; determining, in response to an audio playback device selection of the terminal based on the at least one target audio playback device, a first audio playback device selected by the target terminal for playing the target audio; playing the target audio through the first audio playback device; and adjusting the preset weight information corresponding to each type of target data according to the first audio playback device.

Before playing the target audio, the identifier information of the determined target audio playback device may also be sent to the target terminal, so that the target terminal may quickly confirm whether to use the target audio playback device to play the target audio, or to use another audio playback device to play the target audio. The audio playback device selected by the user through the target terminal for playing the target audio is determined as the first audio playback device.

The target terminal can be a terminal that triggers the audio playback command, or any terminal in the audio playback system, which will not be particularly defined herein. After the user selects the first audio playback device, the preset weight information corresponding to each type of target data may be adjusted according to the selected first audio playback device, so that, when performing weighted summation on the matching degree calculation result corresponding to each type of target data according to the adjusted preset weight information, and obtaining the target matching degree for each audio playback device, only the target matching degree of the first audio playback device is higher than the preset device matching degree threshold. Thus, parameters of the algorithm for the determination of the playback device can be adjusted through the user's selection. By involving users in the training and optimization of the algorithm, the algorithm progressively aligns with user expectations.

Corresponding to the above-mentioned method embodiments, FIG. 2 shows a schematic diagram of an audio playback apparatus applied to an audio playback system. The audio playback system includes at least two audio playback devices. The apparatus includes an obtaining module 20, configured to obtain at least one type of target data in response to a playback command for target audio; where the at least one type of target data includes any one of the following: position information of a detection target, configuration information of each audio playback device in the audio playback system, historical control information of the audio playback system, attribute information of the target audio, and current spatiotemporal information of the audio playback system; a determining module 22, configured to determine at least one target audio playback device from the audio playback system according to the at least one type of target data; and a playback module 24, configured to play the target audio through the at least one target audio playback device.

In the audio playback apparatus, the audio playback device is predicted through multi-dimensional target data. This enables intelligent selection of playback devices for audio playback, rather than determining the preset playback device through the default setting. Consequently, the intelligence level of the audio playback system is significantly enhanced.

Optionally, the at least one type of target data is the position information of the detection target, and the detection target is a target device or a target organism; the determining module 22 is configured to: calculate, according to the position information, a proximity level between the detection target and a preset audible zone of each audio playback device in the audio playback system; where the preset audible zone of each audio playback device is used to indicate a target connected space where the corresponding audio playback device is located; and determine, from the audio playback system, at least one target audio playback device whose proximity level is greater than or equal to a preset proximity threshold.

Optionally, the at least one type of target data is the configuration information of each audio playback device in the audio playback system; the determining module 22 is configured to: obtain an audio-visual type of the target audio, where the audio-visual type is used to indicate whether the target audio is video-associated audio or non-video-associated audio; calculate, according to the audio-visual type and the configuration information of each audio playback device, a device compatibility degree for each audio playback device in the audio playback system; determine an audio playback device whose device compatibility degree is greater than a preset device compatibility threshold as the target audio playback device, and obtain the at least one target audio playback device.

Optionally, the at least one type of target data is the historical control information of the audio playback system; the determining module 22 is configured to: obtain current time information and genre tag information of the target audio; determine through matching, from the historical control information, at least one target audio playback device with a historical preference degree higher than a preset preference degree threshold, according to the current time information and the genre tag information.

Optionally, the at least one type of target data is the attribute information of the target audio; the determining module 22 is configured to: determine a content type of the target audio according to the attribute information; and determine, from the audio playback system, at least one target audio playback device of which a preset compatible content type matches the content type.

Optionally, the at least one type of target data is current spatiotemporal information of the audio playback system, and the current spatiotemporal information includes current weather information and/or current time information; the determining module 22 is configured to: perform behavioral habit feature and emotional feature prediction according to the current spatiotemporal information, to obtain a feature prediction result; and determine through matching, from the audio playback system, at least one target audio playback device of which a feature matching degree with the feature prediction result is greater than a preset feature matching threshold, according to preset feature information of each audio playback device in the audio playback system.

Optionally, the determining module 22 is configured to: calculate a matching degree between each type of target data and each audio playback device, and obtain a matching degree calculation result corresponding to each type of target data; perform, according to preset weight information corresponding to each type of target data, weighted summation on the matching degree calculation result corresponding to each type of target data, and obtain a target matching degree for each audio playback device; and determine an audio playback device whose target matching degree is greater than a preset device matching degree threshold as the at least one target audio playback device.

Optionally, the playback module 24 is configured to: send identifier information of the target audio playback device to a target terminal; determine, in response to an audio playback device selection of the terminal based on the at least one target audio playback device, a first audio playback device selected by the target terminal for playing the target audio; play the target audio through the first audio playback device; and adjust the preset weight information corresponding to each type of target data according to the first audio playback device.

The embodiments of the present disclosure further provide an electronic device, including: a processor, and a memory, where the memory has stored thereon machine-executable instructions that are capable of being executed by the processor, and the processor is configured to execute the machine-executable instructions to perform the above-mentioned audio playback method. The electronic device may be a server or a terminal device.

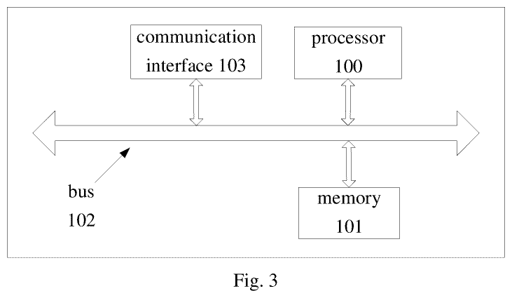

As shown in FIG. 3, the electronic device includes a processor 100 and a memory 101. The memory 101 stores machine executable instructions that can be executed by the processor 100, the machine executable instructions, when executed by the processor 100, cause the processor 100 to implement the above-mentioned audio playback method.

Furthermore, the electronic device in FIG. 3 further includes a bus 102 and a communication interface 103, and the processor 100, the communication interface 103 and the memory 101 are connected via the bus 102.

The memory 101 may include a high-speed random access memory (RAM), or a non-volatile memory (non-volatile memory), for example, at least one disk storage. The communication connection between the system network element and at least one other network element is realized through at least one communication interface 103 (which may be wired or wireless), and the Internet, wide area network, local area network, metropolitan area network, etc. may be used. The bus 102 may be an Industry Standard Architecture (ISA) bus, a Peripheral Component Interconnect (PCI) bus, or an Extended Industry Standard Architecture (EISA) bus, etc. The bus may be categorized as an address bus, a data bus, a control bus, etc. For ease of representation, only one bidirectional arrow is used in FIG. 6, but it does not mean that there is only one bus or one type of bus.

The processor 100 may be an integrated circuit with signal processing capability. In the implementation process, the various steps of the above method may be implemented by an integrated logic circuit of the processor 100 in hardware form or implemented by instructions in the form of software in the processor 100. The processor 100 may be a general-purpose processor, including a central processing unit (CPU), a network processor (NP), etc. The processor 600 may also be a digital signal processor (DSP), an application specific integrated circuit (ASIC), a field programmable gate array (FPGA) or any other programmable logic device, discrete gate or transistor logic device, discrete hardware component. Various methods, steps and logic block diagrams in the embodiments of this application may be implemented or carried out. The general processor may be a micro-processor or any conventional processor, etc. The steps of the method in the embodiments of this application may be directly implemented by a hardware decoding processor, or implemented by a combination of hardware and software modules in the decoding processor. The software modules may be located in a storage medium well-known in the art, such as a random access memory, a flash memory, a read-only memory, a programmable read-only memory, or an electrically erasable programmable memory, a register. The storage medium is located in the memory 101, and the processor 100 reads the information in the memory 101 and finishes the method steps of the above-mentioned embodiment in combination with its hardware, for example, obtaining at least one type of target data in response to a playback command for target audio; wherein the at least one type of target data includes any one of the following: position information of a detection target, configuration information of each audio playback device in the audio playback system, historical control information of the audio playback system, attribute information of the target audio, and current spatiotemporal information of the audio playback system; determining at least one target audio playback device from the audio playback system according to the at least one type of target data; and playing the target audio through the at least one target audio playback device.

In this implementation, the audio playback device is predicted through multi-dimensional target data. This enables intelligent selection of playback devices for audio playback, rather than determining the preset playback device through the default setting. Consequently, the intelligence level of the audio playback system is significantly enhanced.

Optionally, the at least one type of target data is the position information of the detection target, and the detection target is a target device or a target organism; the determining at least one target audio playback device from the audio playback system according to the at least one type of target data includes: calculating, according to the position information, a proximity level between the detection target and a preset audible zone of each audio playback device in the audio playback system; where the preset audible zone of each audio playback device is used to indicate a target connected space where the corresponding audio playback device is located; and determining, from the audio playback system, at least one target audio playback device whose proximity level is greater than or equal to a preset proximity threshold.

Optionally, the at least one type of target data is the configuration information of each audio playback device in the audio playback system; the determining at least one target audio playback device from the audio playback system according to the at least one type of target data includes: obtaining an audio-visual type of the target audio, where the audio-visual type is used to indicate whether the target audio is video-associated audio or non-video-associated audio; calculating, according to the audio-visual type and the configuration information of each audio playback device, a device compatibility degree for each audio playback device in the audio playback system; determining an audio playback device whose device compatibility degree is greater than a preset device compatibility threshold as the target audio playback device, and obtaining the at least one target audio playback device.

Optionally, the at least one type of target data is the historical control information of the audio playback system; the determining at least one target audio playback device from the audio playback system according to the at least one type of target data includes: obtaining current time information and genre tag information of the target audio; determining through matching, from the historical control information, at least one target audio playback device with a historical preference degree higher than a preset preference degree threshold, according to the current time information and the genre tag information.

Optionally, the at least one type of target data is the attribute information of the target audio; the determining at least one target audio playback device from the audio playback system according to the at least one type of target data includes: determining a content type of the target audio according to the attribute information; and determining, from the audio playback system, at least one target audio playback device of which a preset compatible content type matches the content type.

Optionally, the at least one type of target data is current spatiotemporal information of the audio playback system, and the current spatiotemporal information includes current weather information and/or current time information; the determining at least one target audio playback device from the audio playback system according to the at least one type of target data includes: performing behavioral habit feature and emotional feature prediction according to the current spatiotemporal information, to obtain a feature prediction result; and determining through matching, from the audio playback system, at least one target audio playback device of which a feature matching degree with the feature prediction result is greater than a preset feature matching threshold, according to preset feature information of each audio playback device in the audio playback system.

Optionally, the determining at least one target audio playback device from the audio playback system according to the at least one type of target data includes: calculating a matching degree between each type of target data and each audio playback device, and obtaining a matching degree calculation result corresponding to each type of target data; performing, according to preset weight information corresponding to each type of target data, weighted summation on the matching degree calculation result corresponding to each type of target data, and obtaining a target matching degree for each audio playback device; and determining an audio playback device whose target matching degree is greater than a preset device matching degree threshold as the at least one target audio playback device.

Optionally, the playing the target audio through the at least one target audio playback device includes: sending identifier information of the target audio playback device to a target terminal; determining, in response to an audio playback device selection of the terminal based on the at least one target audio playback device, a first audio playback device selected by the target terminal for playing the target audio; playing the target audio through the first audio playback device; and adjusting the preset weight information corresponding to each type of target data according to the first audio playback device.

The embodiments of present disclosure further provide a computer-readable storage medium on which computer-executable instructions are stored, where the computer-executable instructions, when invoked and executed by a processor, cause the processor to implement the above-mentioned audio playback method, including: obtaining at least one type of target data in response to a playback command for target audio; wherein the at least one type of target data includes any one of the following: position information of a detection target, configuration information of each audio playback device in the audio playback system, historical control information of the audio playback system, attribute information of the target audio, and current spatiotemporal information of the audio playback system; determining at least one target audio playback device from the audio playback system according to the at least one type of target data; and playing the target audio through the at least one target audio playback device.

In this implementation, the audio playback device is predicted through multi-dimensional target data. This enables intelligent selection of playback devices for audio playback, rather than determining the preset playback device through the default setting. Consequently, the intelligence level of the audio playback system is significantly enhanced.

Optionally, the at least one type of target data is the position information of the detection target, and the detection target is a target device or a target organism; the determining at least one target audio playback device from the audio playback system according to the at least one type of target data includes: calculating, according to the position information, a proximity level between the detection target and a preset audible zone of each audio playback device in the audio playback system; where the preset audible zone of each audio playback device is used to indicate a target connected space where the corresponding audio playback device is located; and determining, from the audio playback system, at least one target audio playback device whose proximity level is greater than or equal to a preset proximity threshold.

Optionally, the at least one type of target data is the configuration information of each audio playback device in the audio playback system; the determining at least one target audio playback device from the audio playback system according to the at least one type of target data includes: obtaining an audio-visual type of the target audio, where the audio-visual type is used to indicate whether the target audio is video-associated audio or non-video-associated audio; calculating, according to the audio-visual type and the configuration information of each audio playback device, a device compatibility degree for each audio playback device in the audio playback system; determining an audio playback device whose device compatibility degree is greater than a preset device compatibility threshold as the target audio playback device, and obtaining the at least one target audio playback device.

Optionally, the at least one type of target data is the historical control information of the audio playback system; the determining at least one target audio playback device from the audio playback system according to the at least one type of target data includes: obtaining current time information and genre tag information of the target audio; determining through matching, from the historical control information, at least one target audio playback device with a historical preference degree higher than a preset preference degree threshold, according to the current time information and the genre tag information.

Optionally, the at least one type of target data is the attribute information of the target audio; the determining at least one target audio playback device from the audio playback system according to the at least one type of target data includes: determining a content type of the target audio according to the attribute information; and determining, from the audio playback system, at least one target audio playback device of which a preset compatible content type matches the content type.

Optionally, the at least one type of target data is current spatiotemporal information of the audio playback system, and the current spatiotemporal information includes current weather information and/or current time information; the determining at least one target audio playback device from the audio playback system according to the at least one type of target data includes: performing behavioral habit feature and emotional feature prediction according to the current spatiotemporal information, to obtain a feature prediction result; and determining through matching, from the audio playback system, at least one target audio playback device of which a feature matching degree with the feature prediction result is greater than a preset feature matching threshold, according to preset feature information of each audio playback device in the audio playback system.

Optionally, the determining at least one target audio playback device from the audio playback system according to the at least one type of target data includes: calculating a matching degree between each type of target data and each audio playback device, and obtaining a matching degree calculation result corresponding to each type of target data; performing, according to preset weight information corresponding to each type of target data, weighted summation on the matching degree calculation result corresponding to each type of target data, and obtaining a target matching degree for each audio playback device; and determining an audio playback device whose target matching degree is greater than a preset device matching degree threshold as the at least one target audio playback device.

Optionally, the playing the target audio through the at least one target audio playback device includes: sending identifier information of the target audio playback device to a target terminal; determining, in response to an audio playback device selection of the terminal based on the at least one target audio playback device, a first audio playback device selected by the target terminal for playing the target audio; playing the target audio through the first audio playback device; and adjusting the preset weight information corresponding to each type of target data according to the first audio playback device.

The embodiments of the present disclosure provide the audio playback method, the audio playback apparatus, the electronic device, and a computer program product of the storage medium, including a computer-readable storage medium storing program code. The program code includes instructions executable to perform the method in the above-mentioned embodiments. For specific implementation, reference may be made to the method embodiments, which will not be elaborated again herein.

Those skilled in the art may clearly understand that, for the sake of convenience and brevity of description, the specific working process of the system, apparatus and units mentioned above can refer to the corresponding processes in the method embodiments, which are not elaborated again herein.

In the embodiments of the present disclosure, unless explicitly specified or defined otherwise, terms such as “install”, “connect”, and “connection” should be construed in a broad sense. For example, it may be a fixed connection, or a detachable connection, or integral; it may be a mechanic connection or an electrical connection; it may be a direct connection, or an indirect connection via an intermediate medium, or an interior connection of two elements. A person of ordinary skill in the art may derive the specific meaning of the term in the present disclosure according to the specific situation.

If the function is implemented in the form of software functional units and sold or used as an independent product, it may be stored in a computer readable storage medium. Based on this comprehension, essence of the technical solutions of this application, or the part contributing to the prior art, or part of the technical solutions, may be embodied in the form of a software product. The computer software product is stored in a storage medium, and includes a number of instructions to enable a computer device (which may be a personal computer, a server, or a network device, etc.) to perform all or part of the steps of method described in the various embodiments of this application. The storage medium includes a USB flash disk, a mobile hard disk, a read-only memory (Read-Only Memory, ROM), a random access memory (Random Access Memory, RAM), a magnetic disk, an optical disk, or other medium which can store program code.

In the embodiments of the present disclosure, it should be appreciated that, such words as “in the middle of”, “on/above”, “under/below”, “left”, “right”, “vertical”, “horizontal”, “inside” and “outside” may be used to indicate directions or positions as viewed in the drawings, and they are merely used to facilitate the description in the present disclosure, rather than to indicate or imply that a device or member must be arranged or operated at a specific position. In addition, such words as “first”, “second” and “third” may be merely used to differentiate different components rather than to indicate or imply any importance.

It should be noted that the above embodiments are merely specific implementations of the present disclosure and are used to illustrate the technical solutions of the present disclosure, but shall not be construed as limiting the present disclosure. The scope of the present disclosure is not limited to these embodiments. As can be appreciated by a person skilled in the art, although the present disclosure has been described in detail with reference to the foregoing embodiments, any modifications or variations of the technical solutions in the aforementioned embodiments, or equivalent replacements of part of the technical features within the scope of the disclosed technology, may still be made by those skilled in the art. These modifications, variations or replacements do not make the essence of the corresponding technical solutions depart from the spirit and scope of the technical solutions of the embodiments of the present application. The scope of the present disclosure shall be subject to the scope defined by the appended claims.

What is claimed is:

1. An audio playback method, applied to an audio playback system, wherein the audio playback system comprises at least two audio playback devices, and the method comprises:
obtaining at least one type of target data in response to a playback command for target audio; wherein the at least one type of target data comprises: position information of a detection target, configuration information of each audio playback device in the audio playback system, historical control information of the audio playback system, attribute information of the target audio, and current spatiotemporal information of the audio playback system;
determining at least one target audio playback device from the audio playback system according to the at least one type of target data; and
playing the target audio through the at least one target audio playback device;
wherein the determining at least one target audio playback device from the audio playback system according to the at least one type of target data comprises:
calculating a matching degree between each type of target data and each audio playback device, obtaining a matching degree calculation result corresponding to each type of target data;
performing, according to preset weight information corresponding to each type of target data, weighted summation on the matching degree calculation result corresponding to each type of target data, and obtaining a target matching degree for each audio playback device; and
determining an audio playback device whose target matching degree is greater than a preset device matching degree threshold as the at least one target audio playback device;
wherein preset weight information αⱼ corresponding to a j-th type of target data is determined through the following formula:
αⱼ=βⱼ×(1+γⱼ×hⱼ)
wherein, βⱼ is a preset base weight for the j-th type of target data; γⱼ is a learning rate coefficient for the j-th type of target data, γⱼ∈[0,1], and γⱼ is a hyperparameter used to control the degree of parameter adjustment for a machine learning model in each step of an optimization algorithm; hⱼ is a historical success rate index, hⱼ∈[0,1], and hⱼ is correlated with whether the matching degree calculation result of the corresponding target data successfully predicts the audio playback device actually used by a user.

2. The method according to claim 1, wherein the at least one type of target data is the position information of the detection target, and the detection target is a target device or a target organism;
the determining at least one target audio playback device from the audio playback system according to the at least one type of target data comprises:
calculating, according to the position information, a proximity level between the detection target and a preset audible zone of each audio playback device in the audio playback system; and
determining, from the audio playback system, at least one target audio playback device whose proximity level is greater than or equal to a preset proximity level threshold.

3. The method according to claim 1, wherein the at least one type of target data is the configuration information of each audio playback device in the audio playback system;
the determining at least one target audio playback device from the audio playback system according to the at least one type of target data comprises:
obtaining an audio-visual type of the target audio, wherein the audio-visual type is used to indicate whether the target audio is video-associated audio or non-video-associated audio;
calculating, according to the audio-visual type and the configuration information of each audio playback device, a device compatibility degree for each audio playback device in the audio playback system; and
determining an audio playback device whose device compatibility degree is greater than a preset device compatibility threshold as the target audio playback device, and obtaining the at least one target audio playback device.

4. The method according to claim 1, wherein the at least one type of target data is the historical control information of the audio playback system;
the determining at least one target audio playback device from the audio playback system according to the at least one type of target data comprises:
obtaining current time information and genre tag information of the target audio; and
determining through matching, from the historical control information, at least one target audio playback device with a historical preference degree higher than a preset preference degree threshold, according to the current time information and the genre tag information.

5. The method according to claim 1, wherein the at least one type of target data is the attribute information of the target audio;
the determining at least one target audio playback device from the audio playback system according to the at least one type of target data comprises:
determining a content type of the target audio according to the attribute information; and
determining, from the audio playback system, at least one target audio playback device of which a preset compatible content type matches the content type.

6. The method according to claim 1, wherein the at least one type of target data is current spatiotemporal information of the audio playback system, the current spatiotemporal information comprises current weather information and/or current time information;
the determining at least one target audio playback device from the audio playback system according to the at least one type of target data comprises:
performing behavioral habit feature and emotional feature prediction according to the current spatiotemporal information, to obtain a feature prediction result; and
determining through matching, from the audio playback system, at least one target audio playback device of which a feature matching degree with the feature prediction result is greater than a preset feature matching threshold, according to preset feature information of each audio playback device in the audio playback system.

7. The method according to claim 1, wherein the playing the target audio through the at least one target audio playback device comprises:
sending identifier information of the target audio playback device to a target terminal;
determining, in response to an audio playback device selection of the terminal based on the at least one target audio playback device, a first audio playback device selected by the target terminal for playing the target audio;
playing the target audio through the first audio playback device; and
adjusting the preset weight information corresponding to each type of target data according to the first audio playback device.

8. An audio playback apparatus, applied to an audio playback system, wherein the audio playback system comprises at least two audio playback devices, and the apparatus comprises:
an obtaining module, configured to obtain at least one type of target data in response to a playback command for target audio; wherein the at least one type of target data comprises any one of the following: position information of a detection target, configuration information of each audio playback device in the audio playback system, historical control information of the audio playback system, attribute information of the target audio, and current spatiotemporal information of the audio playback system;
a determining module, configured to determine at least one target audio playback device from the audio playback system according to the at least one type of target data; and
a playback module, configured to play the target audio through the at least one target audio playback device;
wherein the determining module is further configured to:
calculate a matching degree between each type of target data and each audio playback device, and obtain a matching degree calculation result corresponding to each type of target data;
perform, according to preset weight information corresponding to each type of target data, weighted summation on the matching degree calculation result corresponding to each type of target data, and obtain a target matching degree for each audio playback device; and
determine an audio playback device whose target matching degree is greater than a preset device matching degree threshold as the at least one target audio playback device;
wherein preset weight information αⱼ corresponding to a j-th type of target data is determined through the following formula:
αⱼ=βⱼ×(1+γⱼ×hⱼ)
wherein, βⱼ is a preset base weight for the j-th type of target data; Y; is a learning rate coefficient for the j-th type of target data, γⱼ∈[0,1], and γⱼ is a hyperparameter used to control the degree of parameter adjustment for a machine learning model in each step of an optimization algorithm; hⱼ is a historical success rate index, hⱼ∈[0,1], and hⱼ is correlated with whether the matching degree calculation result of the corresponding target data successfully predicts the audio playback device actually used by a user.

9. An electronic device, comprising: a processor, and a memory, wherein the memory has stored thereon machine-executable instructions that are capable of being executed by the processor, and the processor is configured to execute the machine-executable instructions to perform the audio playback method according to claim 1.

10. A non-transitory computer-readable storage medium on which computer-executable instructions are stored, wherein the computer-executable instructions, when invoked and executed by a processor, cause the processor to implement the audio playback method according to claim 1.
